(19) United States
(12) Patent Application Publication
(10) Pub. No.: US 2022/0143561 A1
(43) Pub. Date: May 12, 2022

(54) POSITIVE DISPLACEMENT MIXER

(71) Applicant: The Procter & Gamble Company, Cincinnati, OH (US)

(72) Inventors: Emilio Javier Tozzi, West Chester, OH (US); Sarah Noelle Absher, Cincinnati, OH (US); Paul Ervin Williger, Springboro, OH (US)

(21) Appl. No.: 17/519,620

(22) Filed: Nov. 5, 2021

Related U.S. Application Data
(60) Provisional application No. 63/112,909, filed on Nov. 12, 2020.

(51) Int. Cl. B01F 5/10; B01F 5/00; B01F 15/02; B01F 15/00

(52) U.S. Cl. CPC B01F 5/102; B01F 5/0082; B01F 2005/0028; B01F 15/0237; B01F 15/0087; B01F 5/108

(57) ABSTRACT

A positive displacement mixer and method for mixing a product that mixes at least two materials into a homogenous product. The positive displacement mixer has at least one positive displacement element having a length, a primary compartment, and a moving element, and two or more minor positive displacement elements each having a length, a minor compartment, and a moving element. The primary compartment and the minor compartments are fluidly connected and during mixing the primary compartment and minor compartments are closed to the atmosphere.

### FIELD OF THE INVENTION

The present invention relates to a mixer and method for making a product by mixing in a specific sequence that exploits the “split-and recombine” principle.

### BACKGROUND OF THE INVENTION

Today, most consumers buy products at the store or online that were made in large batches without customization. For each product category, there are often numerous brands and each brand often sells several items. For example, if a consumer is looking to purchase face moisturizer from a drugstore, they will have to select from several brands (e.g. Olay®, Neutrogena®, Gamier®, L'Oreal®, Eucerine®, CeraVe®, etc.). Once they decide on a brand, there are often several products within that brand to choose from. For instance, if a consumer decides she wants to purchase Olay® face moisturizer, she may then have to select from over a dozen different face moisturizing products including night face moisturizer, micro-sculpting cream, ultra-rich moisturizers, hydrating mineral sunscreen, calming face moisturizer, etc. It can take a consumer a relatively long time select a product and then they may not be confident that the product meets their unique needs.

Thus, some consumers may want a personalized, customized or bespoke product that meets their unique needs. For example, a consumer may want skin care product that is specifically designed for their skin (e.g. oily, dry, acne prone, aging, fragrance-free, etc.) or a shampoo, conditioner, or styling product that is specifically designed for their hair (e.g. curly, fine, colored, dandruff, etc.).

However, it can be difficult to make customized, personalized, or bespoke products in a scalable manner where relatively small amounts (i.e. between 30 mL and 1.5 L) need to be automatically mixed and packed. This small volume introduces several problems that are not prominent when making large batches. For instance, it can be difficult to mix small batches to form homogenous mixtures. Also, when making smaller batches there can be higher loss and more washouts needed between batches, as compared to making compositions in mass.

Therefore, there is a need for a mixer and an efficient process for making small batches of homogenous compositions that has reduced loss and does not require washouts between batches of different compositions.

### SUMMARY OF THE INVENTION

A method for mixing a product (a) providing a positive displacement mixer comprising: (i) one or more primary positive displacement elements each comprising a primary compartment comprising a primary volume and a length; (ii) two or more minor positive displacement elements each comprising a minor compartment comprising a minor volume and a length; wherein the one or more primary compartments and the two or more minor compartments are fluidly connected; (b) loading the one or more primary compartments with at least two materials; (c) closing the primary and minor positive displacement elements to the atmosphere; (d) mixing the one or more materials using laminar flow by a mixing method selected from the group consisting of Method A, Method B, Method C, and combinations thereof; wherein Method A comprises: (i) transferring the materials from the one or more primary compartments to each minor compartment one at a time; (ii) then, simultaneously transferring the material from the minor compartments to the one or more primary compartments to complete one cycle; (iii) repeating steps i to ii until the desired level of mixedness is obtained forming a product; wherein Method B comprises: (i) simultaneously transferring the materials from the one or more primary compartments to the two or more minor compartments; (ii) then, transferring all the material from each minor compartment to the primary compartment one at a time to complete one cycle; (iii) repeating steps i to ii until the desired level of mixedness is obtained forming a product; wherein Method C comprises: (i) simultaneously transferring the materials from the one or more primary compartments to the two or more minor compartments; (ii) then, simultaneously transferring the material from the minor compartments to the one or more primary compartments to complete one cycle; (iii) repeating steps i to ii until the desired level of mixedness is obtained forming a product; (e) dispensing the product into a final container.

A method for mixing a product (a) providing a positive displacement mixer comprising: (i) two or more primary positive displacement elements each comprising a primary compartment comprising a primary volume; (ii) two or more minor positive displacement elements each comprising a minor compartment comprising a minor volume; wherein the two or more primary compartments and the two or more minor compartments are fluidly connected; (b) loading the two or more primary compartments with at least two materials in each primary compartment or loading the two or more minor compartments with at least two materials in each compartment; (c) closing the primary and minor positive displacement elements to the atmosphere; (d) mixing the one or more materials using laminar flow by a mixing method selected from the group consisting of Method A, Method B, Method C, Method D, and Method E, and combinations thereof; wherein Method A comprises: (i) transferring the materials from the one or more primary compartments to each minor compartment one at a time; (ii) then, simultaneously transferring the material from the minor compartments to the one or more primary compartments to complete one cycle; (iii) repeating steps i to ii until the desired level of mixedness is obtained forming a product; wherein Method B comprises: (i) simultaneously transferring the materials from the one or more primary compartments to the two or more minor compartments; (ii) then, transferring all the material from each minor compartment to the primary compartment one at a time to complete one cycle; (iii) repeating steps i to ii until the desired level of mixedness is obtained forming a product; wherein Method C comprises: (i) simultaneously transferring the materials from the one or more primary compartments to the two or more minor compartments; (ii) then, simultaneously transferring the material from the minor compartments to the one or more primary compartments to complete one cycle; (iii) repeating steps i to ii until the desired level of mixedness is obtained forming a product; wherein Method D comprises: (i) transferring the materials from the two or more minor compartments to each primary compartment one at a time; (ii) then, simultaneously transferring the material from the two or more primary compartments to the two or more minor compartments to complete one cycle; (iii) repeating steps i to ii until the desired level of mixedness is obtained forming a product; wherein Method E comprises: (i) simultaneously transferring the materials from the two or more minor compartments to the two or more primary compartments; (ii) then, transferring all the material from each primary compartment to the minor compartments one at a time to complete one cycle; (iii) repeating steps i to ii until the desired level of mixedness is obtained forming a product; (e) dispensing the product into a final container.

A positive displacement mixer for mixing a product that mixes at least two materials into a homogenous product, the device comprising: (a) at least three positive displacement elements comprising: (i) a primary positive displacement element comprising a length, primary compartment, and a moving element; (ii) two or more minor positive displacement elements each comprising a length, a minor compartment, and a moving element; wherein the primary compartment and the minor compartments are fluidly connected; wherein during mixing the primary compartment and minor compartments are closed to the atmosphere; wherein the primary compartment and the minor compartments comprise variable volumes as determined by moving the moving element across the length of the positive displacement elements.

### BRIEF DESCRIPTION OF THE DRAWINGS

While the specification concludes with claims particularly pointing out and distinctly claiming the subject matter of the present invention, it is believed that the invention can be more readily understood from the following description taken in connection with the accompanying drawings, in which:

FIG. 1 is a schematic cross-section view of a positive displacement mixer with three positive displacement elements each having a moving element;

FIG. 2A is a schematic of split and recombine Method A;

FIG. 2B is a schematic of split and recombine Method B;

FIG. 3A is a plot of the displacement of piston 1 (primary piston) in a mixer with three positive displacement elements like in FIG. 1 versus time;

FIG. 3B is a plot of the displacement of piston 2 (minor piston) in a mixer with three positive displacement elements like in FIG. 1 versus time;

FIG. 3C is a plot of the displacement of piston 3 (minor piston) in a mixer with three positive displacement elements like in FIG. 1 versus time;

FIG. 4A is a plot of the displacement of piston 1 (primary piston) in a mixer with three positive displacement elements like in FIG. 1 versus time;

FIG. 4B is a plot of the displacement of piston 2 (minor piston) in a mixer with three positive displacement elements like in FIG. 1 versus time;

FIG. 4C is a plot of the displacement of piston 3 (minor piston) in a mixer with three positive displacement elements like in FIG. 1 versus time;

FIG. 5A is a plot of the displacement of piston 1 (primary piston) in a mixer with three positive displacement elements like in FIG. 1 versus time;

FIG. 5B is a plot of the displacement of piston 2 (minor piston) in a mixer with three positive displacement elements like in FIG. 1 versus time;

FIG. 5C is a plot of the displacement of piston 3 (minor piston) in a mixer with three positive displacement elements like in FIG. 1 versus time;

FIG. 6A shows a mixer with four positive displacement elements;

FIG. 6B shows a mixer with five positive displacement elements;

FIG. 6C shows a mixer with six positive displacement elements;

FIG. 6D shows a mixer with seven positive displacement elements;

FIG. 6E shows a mixer with a plurality of positive displacement elements;

FIG. 7A is a plot of the displacement of the first piston (primary piston) in a mixer with four positive displacement elements like in FIG. 6A versus time;

FIG. 7B is a plot of the displacement of the second piston (minor piston) in a mixer with four positive displacement elements like in FIG. 6A versus time;

FIG. 7C is a plot of the displacement of the third piston (minor piston) in a mixer with four positive displacement elements like in FIG. 6A versus time;

FIG. 7D is a plot of the displacement of the fourth piston (minor piston) in a mixer with four positive displacement elements like in FIG. 6A versus time;

FIG. 8 shows a mixer with a positive displacement element mixing-and-conveying train;

FIGS. 9A, 9B, and 9C shows a cross-section of configurations for a mixer with three positive displacement elements each having a piston;

FIG. 9D shows a perspective view of a configuration for a mixer with four positive displacement elements;

FIG. 10 shows a positive displacement mixer with four positive displacement elements for mixing and three auxiliary elements;

FIG. 11A shows a positive displacement mixer where two positive displacement elements can each have primary compartments and two positive displacement elements can each have minor compartments;

FIGS. 11B-11E show lamination patterns that can be achieved using the mixer in FIG. 11A;

FIG. 12 is a cross-section of a positive displacement mixer with two pistons and a third compartment formed by a moving lid;

FIGS. 13A, 13B, and 13C are cross-sections of a positive displacement mixer that illustrates loading and unloading the materials into and out of the mixer in order to get high material utilization;

FIG. 14A is a cross-section of a positive displacement mixer with a channel to help facilitate loading material into the mixer to get high material utilization;

FIG. 14B is a cross-section of a positive displacement mixer with two channels to facilitate loading material and unloading material into and from the mixer to get high material utilization;

FIGS. 15A and 15B are a cross-section view of a positive displacement mixer arranged in a T-configuration;

FIG. 16A is a still frame of a mixer with the materials in the primary positive displacement element before mixing begins;

FIG. 16B is a still frame of a mixer where the materials are split and transferred to the minor positive displacement elements;

FIG. 16C is a still frame of a mixer where the material in one minor positive displacement element is transferred back to the primary positive displacement element;

FIG. 16D is a still frame of a mixer where the material in the other minor positive displacement element is transferred back to the primary positive displacement element;

FIG. 16E is a still frame of a mixer where the mixing is complete, and the product is homogeneous;

FIG. 17 is a photograph of mixer with three positive displacement elements each having a piston loaded with facial cream base and red dye; and

FIG. 18 is a chart showing the standard deviation of the hue versus cycle for four samples.

### DETAILED DESCRIPTION OF THE INVENTION

Some consumers may want a product that is made in a small batch and personally designed for them. To make such bespoke, customized or personalized products, such as personal care products, in a scalable manner, one needs to automatically mix small amounts of solid and liquid materials (e.g. mix one jar or bottle at a time, between 30 mL to 1.5 L) and pack them. The small volume involved introduces the following major problems that are not prominent when making large batches:
1) Material Utilization and Loss in the Equipment. When traditional batch making equipment (i.e. a tank with agitator) is reduced in volume, the % yield is decreased from the system, resulting in a higher loss, more washout, and increased waste and wastewater that needs to be treated and monitored. Therefore, scaling down traditional batch making equipment to a single jar or bottle is not a feasible solution because of the excessive product loss. New equipment and/or process can be used to mix small volumes that can minimize loss of material between one batch and the next. Related to this problem is a need for the mixer to be “self-cleaning” or “self-wiping,” because if no washout is needed between batches there is a great benefit in terms of reduced cross-contamination, reduced cost of materials lost, as well as reduced use of wash water, waste streams, waste treatment and related infrastructure and energy footprint.
2) Ensuring Homogeneity. When mixing is scaled down, it can change the fluid dynamics of the liquid product and make more difficult to make a homogenous mixture. If traditional batch making systems (i.e. tank and agitator) are scaled down, the smaller equipment introduces smaller characteristic dimensions which reduce the Reynolds Number, therefore reducing the tendency of turbulent mixing. With a reduction in turbulence in traditional batch systems, the system becomes more laminar in mixing and reduces mixing efficiency in-tank, resulting in long mixing times for homogeneity or non-homogeneous product. Furthermore, some products, including many beauty products like lotions, serums, body wash, shampoos, and conditions, can be high viscosity, can exhibit non-Newtonian behavior such as “shear thinning” behavior, can have high-yield-stress, and/or can require blending of multiple materials that have widely different rheological properties, making it even more difficult to make a homogenous mixture on a small scale.
3) High Turbulence. Existing mixing equipment, such as in-tank agitation, or mixing with high shear stresses, like centrifugal mixing, can cause uneven distribution of shear stress, with areas of high energy dissipation or mechanical “hot-spots” which can result in shear degradation of the product. This is especially problematic for products that have high yield stress (e.g. conditioners and other products with gel networks formed from fatty alcohols or products containing wax-like ingredients) that can degrade when mixed at ambient temperature with high shear stresses or hydrodynamic stress. This can result in a significant loss of product viscosity, which may not be acceptable to consumers, or can be compensated by adding other rheology modifiers (like polymers) which will impact the feel and in-use experience of the product.
4) Homogenizing Immiscible Fluids. Immiscible fluids (e.g. oil and water, silicone and water) can require high shear energy to disperse or emulsify the fluids into one another. Traditionally, this can be done with a high shear device like a rotor-stator mill in a continuous flow process. However, using this type of high shear device is not feasible for a small volume of product (e.g. a single jar or bottle), because of the loss of material in the equipment and the batch size required to get efficient turnover and mixing through the high shear device.
5) Adding Immiscible Materials in Neat Form. Currently marketed equipment designed to mix a single jar or bottle (e.g. centrifugal mixers such as gyroscopic mixers and vortex mixers, vibrational mixers, and acoustic mixers) require immiscible fluids to be pre-dispersed into a carrier fluid that is compatible with the product prior to adding to the finished product. This generally requires materials like silicone and oils to be emulsified in water off-line to form an intermediate product, which can result in a complex supply chain requiring pre-manipulation of materials prior to final product making Furthermore, the inability to add materials in “neat” or in their pure form limits the formulation space available for customization.
6) Limited Variation in Final Packaging and/or Large Headspace. Current centrifugal mixers that are designed to mix a single jar or bottle are generally designed to mix the product in the final container. This can require specific packaging dimensions in the ratio of length/height of the package (e.g. a tall bottle with a ratio of 3:1 would work, however a jar with a ratio of 0.5:1 is not feasible) and/or require a large headspace in the package for efficient mixing from top to bottom of the package (e.g. greater than or equal to 40% by volume headspace). Other current marketed equipment, like acoustic or vibrational mixers, can cause high aeration of the product and may not feasible for products many products, especially those containing surfactant or foaming agents (e.g. shampoo, body wash, etc.). Furthermore, with current solutions, as the product viscosity increases, either the packaging dimensions and head space required to mix efficiently can be further increased and/or the mixing time to homogeneity increases, thus decreasing throughput of the equipment. For example, some currently marketed options require approximately 20-60% headspace for mixing high viscosity fluids, which is not consumer preferred because it appears that the package is significantly underfilled.
7) Mix on Single Jar Scale. Currently marketed equipment cannot mix on the single jar scale (e.g. about 25 mL to about 1500 mL, alternatively from about 30 mL to about 1000 mL, and alternatively from about 30 mL to about 500 mL) without causing product aeration or foaming during mixing, which is especially problematic for products with high yield stress that can incorporate and retain small bubbles and are difficult to deaerate. Centrifugal mixers and gyroscopic mixers rely on headspace during mixing and the air in the headspace is incorporated into the product during mixing and results in a decrease in product, aeration of the product, and/or foaming in the product if the product contains surfactant or foaming agents. Vibrational or acoustic mixers rely on vibrational or acoustic energy can also trap air in the product, since the product and/or package are generally open to the atmosphere during mixing. The unwanted incorporation of air during mixing results in significant density loss or foaming for surfactant-based products. Furthermore, if the product contains a high yield stress or solid-like structures (e.g. gel network and/or wax-like materials), this aeration is permanent in the product and cannot be removed unless additional processing steps are completed (e.g. applying vacuum), which are not feasible in the finished package.

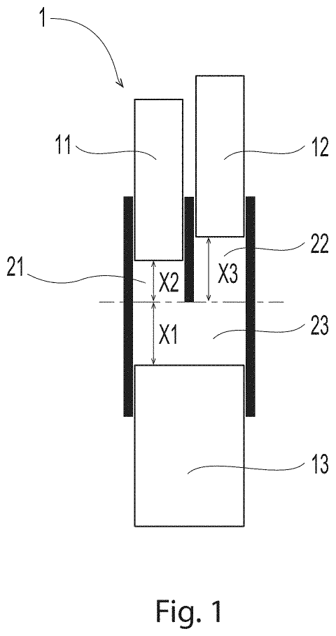

It was found that positive displacement elements that mix by transferring portions of fluid between three or more positive-displacement compartments in a specific sequence can make homogenous products on a small scale using laminar flow. As shown in FIG. 1, which is a schematic of a positive displacement mixer 1, the positive displacement elements 11, 12, and 13 mix by transferring portions of fluid between the three compartments 21, 22, and 23 in a specific sequence that exploits the “split-and recombine” principle. The fluid is split and recombined in a repetitive cycle, such that infinite layers are created in the product to achieve homogeneity. The positive displacement compartments can be self-cleaning because the positive displacement elements that are used for mixing can wipe clean with each swipe (e.g. by pistons), as described hereafter.

As shown in FIG. 1, compartments 21, 22, and 23 can have a fixed volume and/or a variable volume. In some examples, the volume of the compartment can be varied by a moving element. The moving element can be any suitable means including, but not limited to, a piston or syringe plunger, rolling diaphragms, etc. In addition to being able to make different size batches, it can be desirable to have variable volume compartments because it can help with mixing and achieve the mixing cycle and at the end of the mixing process and the excess material can be easily wiped or otherwise expelled from the mixer with a high degree of utilization. For instance, collapsing the volume of the primary compartment and/or minor compartments to zero can help purge all of the fluid after mixing into the final container, which limits loss and can eliminate or significantly limit cleaning the mixer between batches.

The mixer can include three or more positive displacement elements that can mix materials using laminar flow. A mixer with only two displacement elements will generally push the materials back and forth between two chambers, which may work, particularly with low-viscosity products, due to turbulence, or some viscoelastic products due to flow instabilities. In other words, in laminar flow the materials will cycle back and forth in a reversible manner and in some instances may not have substantial rearrangement of the material portions.

Unlike currently marketed equipment, which require fluid inertia and/or turbulence to efficiently mix fluids, the positive displacement mixer, described herein, does not require low viscosity fluids and/or large tanks to achieve efficient mixing. The positive displacement mixer can efficiently mix fluids of low or high viscosity including thick creams and pastes to homogeneity. The positive displacement mixer can mix with laminar flow, which can help maintain product structure and yield stress. Since the total volume of the positive displacement compartments can be constant during mixing and the compartments can be closed to the atmosphere with substantially no head space in the equipment (e.g. less than 15% headspace, alternatively less than 10% headspace, alternatively less than 5% headspace, alternatively less than 3% headspace, alternatively less than 1% headspace, alternatively approximately 0% headspace), there can be no aeriation or foaming of the product during the mixing process. In addition, the product can be mixed in an external mixing container, and can be subsequently dispensed into the final container, allowing for infinite variation in package shape and size.

The positive displacement mixer solves the problems described herein as follows:
1) The mixer minimizes material utilization and loss in the equipment because it can be “self-cleaning” or “self-wiping”, requiring no washout between batches.
2) The mixer can ensure homogeneity/well-mixedness by efficiently mixing relatively high viscosity liquids in laminar conditions.
3) The mixer can reduce turbulent mixing by employing more evenly distributed and lower intensity shear stresses on the product during mixing by using the gentlest flow conditions necessary for mixing, which results in maintaining the integrity of the product structure.
4) The mixer can homogenize immiscible fluids at single jar scale up to 1.5 L without the need of high shear.
5) The mixer can allow all materials to be added into the finished product in their neat form.
6) The mixer can allow for any packaging shape, size and minimized headspace because the product can be mixed in an external mixing container and can be subsequently dispensed into the final container.
7) The mixer can allow the product to mix without the incorporation of air into the final product, which can maintain product density and/or can eliminate foaming

The positive displacement mixer can use a variety of methods to mix materials. However, a method where the components are transferred in a sequence that does not replicate the initial configuration can be the most efficient, as described in Methods A, B, and C, hereafter. Methods A, B, and C can produce fast and reliable mixing as the layers are exponentially multiplied across the cycles and due to a highly controlled flow pattern rather than depending on random asymmetries caused by fluid properties.

The positive displacement mixer can use the split and recombine principle as follows in Method A, Method B, Method C, and combinations thereof.

Method A
Step 1. The initial packet of materials, which can include both solids (e.g. powders, semi-solids gels) and liquids, to be mixed can be initially loaded into the one or more primary compartments.
Step 2A. A portion of the material can be transferred into a first minor compartment.
Step 2B. Another portion of material from the one or more primary compartments can be transferred to a second minor compartment. In some examples, there can be more than two minor compartments (e.g. n), then n-2 steps can be added where material is transferred sequentially from the primary compartment into these minor compartments one portion at a time.
Step 3. The material from the two or more minor compartments can be transferred simultaneously into the one or more primary compartments. At this point one cycle of split and recombine is complete.
Step 4. A new cycle can be started repeating steps 1-3. The process can be repeated to complete a number of cycles that achieves a desired level of mixedness, for example 15 to 30 cycles. The layers generated decrease exponentially in thickness, by a factor of 1/(2\hat{ }n) where n is the number of cycles. For example, in 15 cycles the layers will be reduced by a factor of 1/(2\hat{ }15)=1/32768 times the initial layer thickness. In 30 cycles the layer thickness will be 1/(2\hat{ }30)=9.3*10\hat{ }−10 times the initial layer size (i.e. one billionth the size of the initial layer). At such small dimensions, material diffusion can become dominant and discrete layers can cease to exist as such, the material has been effectively homogenized.

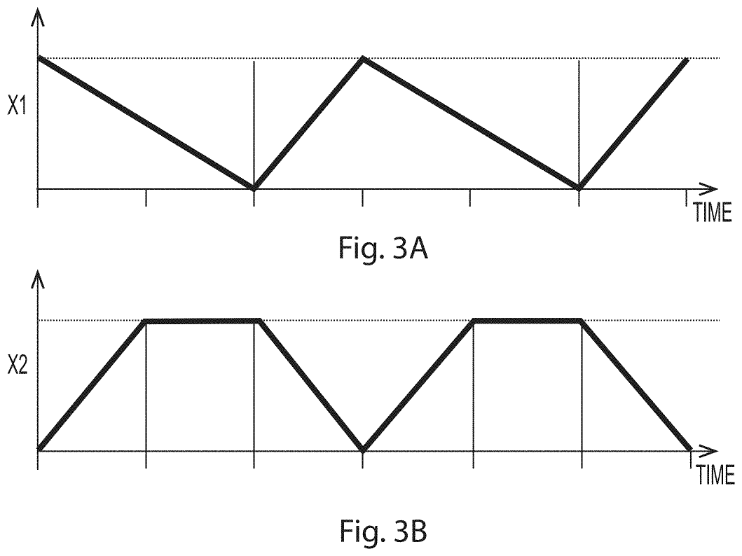

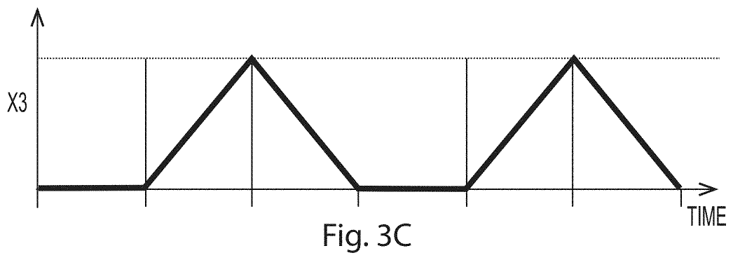

A schematic of Method A is illustrated in FIG. 3A.

Method B
Step 1. The initial packet of materials, which can include both solids and liquids, to be mixed can be initially loaded into the one or more primary compartments.
Step 2. All the material can be simultaneously transferred to the two or more minor compartments.
Step 3A. The material from the first minor compartment can be transferred to the one or more primary compartments.
Step 3B. The material from a second minor compartment can be transferred to the one or more primary compartments. If there are more than 2 minor compartments (e.g. n), then n-2steps can be added where material is transferred sequentially from these minor compartments one portion at a time into the primary compartment. At this point one cycle of split and recombine is complete.
Step 4. A new cycle can be started repeating steps 2-3B. The process can be repeated to complete a number of cycles that achieves a desired level of mixedness, for example 15 to 30 cycles. A schematic of Method B is illustrated in FIG. 3B.

Method C
Step 1. The initial packet of materials, which can include both solids and liquids, to be mixed can be initially loaded into the one or more primary compartments.
Step 2. All the material can be simultaneously transferred to the two or more minor compartments.
Step 3. The material from the two or more minor compartments can be transferred simultaneously into the one or more primary compartments. At this point one cycle is complete.
Step 4. A new cycle can be started repeating steps 2-3B.

In Methods A, B, and C the materials are loaded into the primary compartment. In other examples, the materials can alternatively be loaded into the two or more minor compartments. In this configuration, the materials will be mixed equally well due to the split and recombine principle, which can be effective to mix relatively small volumes of material.

Method D
Step 1. The initial packet of materials, which can include both solids (e.g. powders, semi-solids gels) and liquids, to be mixed can be initially loaded into the minor compartments.
Step 2. transferring the materials from the two or more minor compartments to each primary compartment one at a time.
Step 3. Simultaneously transferring the material from the two or more primary compartments to the two or more minor compartments to complete one cycle.
Step 4: Repeat steps 2-3 until the desired level of mixedness is obtained.

Method E
Step 1. The initial packet of materials, which can include both solids (e.g. powders, semi-solids gels) and liquids, to be mixed can be initially loaded into the minor compartments
Step 2. Simultaneously transferring the materials from the two or more minor compartments to the two or more primary compartments;
Step 3. Transferring all the material from each primary compartment to the minor compartments one at a time to complete one cycle;
Step 4: Repeat steps 2-3 until the desired level of mixedness is obtained.

In other examples, when there are four or more positive displacement elements, there can be more than one primary displacement elements and the materials can be added to more than one primary compartment. In these examples, the positive displacement mixer can use the split and recombine principle as described in Method A, Method B, Method C, Method D, Method E, and combinations thereof. Methods A, B, and C are described herein and Methods D and E are described as follows:

Method A
Step 1. The initial packet of materials, which can include both solids (e.g. powders, semi-solids gels) and liquids, to be mixed can be initially loaded into a primary compartment. In some examples, the volume of the primary compartment and/or the secondary compartment can be fixed and the primary compartment can be the largest compartment in the mixer by volume.
Step 2A. A portion of the material can be transferred into a first minor compartment.
Step 32B. Another portion of material from the primary compartment can be transferred to a second minor compartment. In some examples, there can be more than two minor compartments (e.g. n), then n-2 steps can be added where material is transferred sequentially from the primary compartment into these minor compartments one portion at a time.
Step 3. The material from the two or more minor compartments can be transferred simultaneously into the primary compartment. At this point one cycle of split and recombine is complete.
Step 4. A new cycle can be started repeating steps 1-3. The process can be repeated to complete a number of cycles that achieves a desired level of mixedness, for example 15 to 30 cycles. The layers generated decrease exponentially in thickness, by a factor of 1/(2\hat{ }n) where n is the number of cycles. For example, in 15 cycles the layers will be reduced by a factor of 1/(2\hat{ }15)=1/32768 times the initial layer thickness. In 30 cycles the layer thickness will be 1/(2\hat{ }30)=9.3*10\hat{ }−10 times the initial layer size (i.e. one billionth the size of the initial layer). At such small dimensions, material diffusion can become dominant and discrete layers can cease to exist as such, the material has been effectively homogenized. A schematic of Method A is illustrated in FIG. 3A.

Method B
Step 1. The initial packet of materials, which can include both solids and liquids, to be mixed can be initially loaded into a primary compartment.
Step 2. All the material can be simultaneously transferred to the two or more minor compartments.
Step 3A. The material from the first minor compartment can be transferred to the primary compartment.
Step 3B. The material from a second minor compartment can be transferred to the primary compartment. If there are more than 2 minor compartments (e.g. n), then n-2 steps can be added where material is transferred sequentially from these minor compartments one portion at a time into the primary compartment. At this point one cycle of split and recombine is complete.

Step 4. A new cycle can be started repeating steps 2-3B. The process can be repeated to complete a number of cycles that achieves a desired level of mixedness, for example 15 to 30 cycles. A schematic of Method B is illustrated in FIG. 3B.

In one example, all of the compartments in the positive displacement elements can have compartments having a variable volume.

Alternatively, in some examples, the compartments in the positive displacement elements can have a fixed volume. The minor compartments of the positive displacement mixer can have approximately equal volume. Alternatively, the minor compartments may not have equal volume. The split and recombine described in Methods A, B, C, and combinations thereof can occur in a cycle that creates a multiplication of layers. Alternatively, the positive displacement mixer can work by splitting the fluid simultaneously from the primary compartment into the minor compartments and then the fluid is recombined simultaneously from the minor compartments into the primary compartment. In principle, this motion can replicate the initial configuration of the fluid over and over and not generate a multiplication of layers. However, in practice, this motion can provide some mixing because of small asymmetries and flow instabilities that prevent exact replication of the initial structure. With some fluids and/or volumes this mixing can be less reliable and efficient and therefore may be less preferred.

FIGS. 3A-5C illustrate the sequence of motion for split and recombination using a mixer, like the mixer in FIG. 1, which has three positive displacement elements each having a moving element that moves throughout the cycle changing the size of the compartment which can dispel materials from the compartment or make a volume for materials to enter the compartment. In the example illustrated in FIGS. 3A-5C, the moving element is a piston. In FIGS. 1 and 3A-5C, the coordinate X1, represents the position of the piston 1 (shown at reference numeral 13 in FIG. 1), X2 represents the position of piston 2 (shown at reference numeral 11 in FIG. 1) , and an X3 represents the position of piston 3 (shown at reference numeral 12 in FIG. 1). In these examples, since piston 1 is larger than pistons 2 and 3, which are approximately equal size, it displaces twice the volume per stroke, as compared to pistons 2 and 3.

FIGS. 3A-C shows the displacement of each piston versus time of pistons 1, 2, and 3, in FIGS. 3A, 3B, and 3C, respectively. In FIGS. 3A, 3B, and 3C the motion is linear in time.

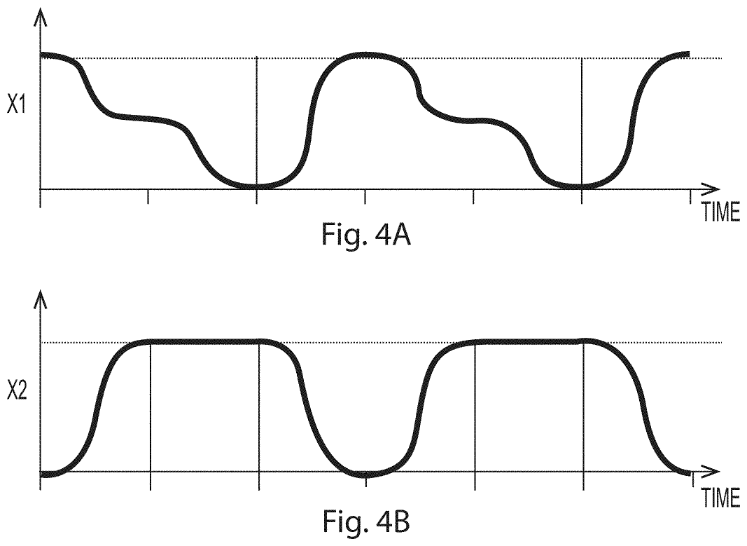

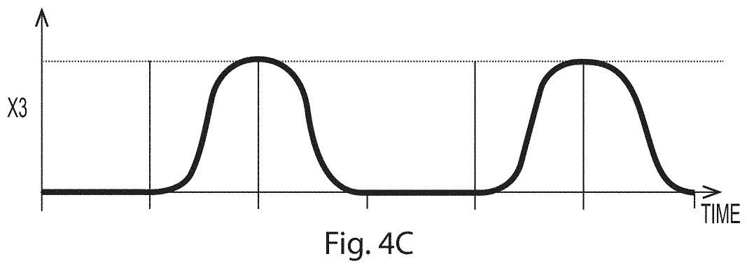

FIGS. 4A-C shows the displacement of each piston versus time of pistons 1, 2, and 3, in FIGS. 4A, 4B, and 4C, respectively. In FIGS. 4A, 4B, and 4C, the motion is nonlinear in time, but accomplishes the same result as the linear motion illustrated in FIGS. 3A, 3B, and 3C. Both linear motion, nonlinear motion, and combinations thereof can both achieves a desired level of mixedness.

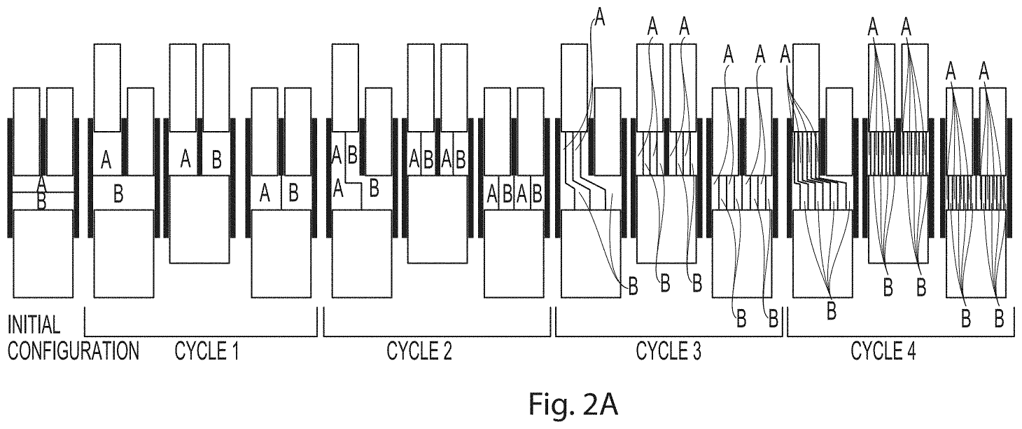

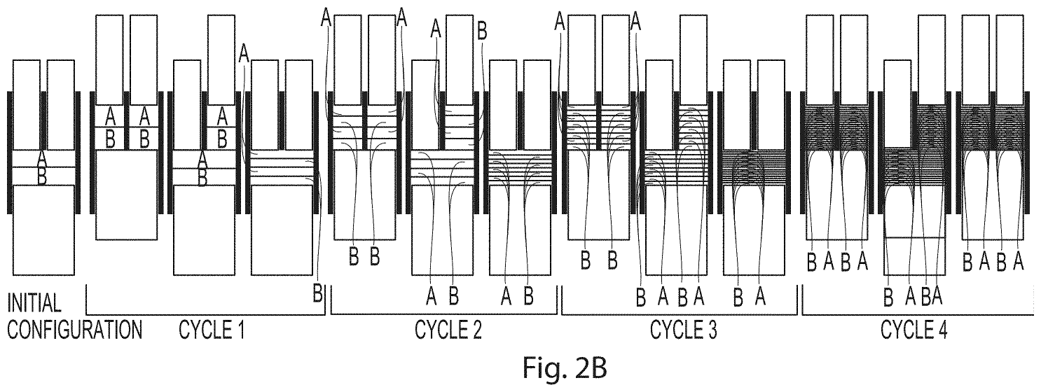

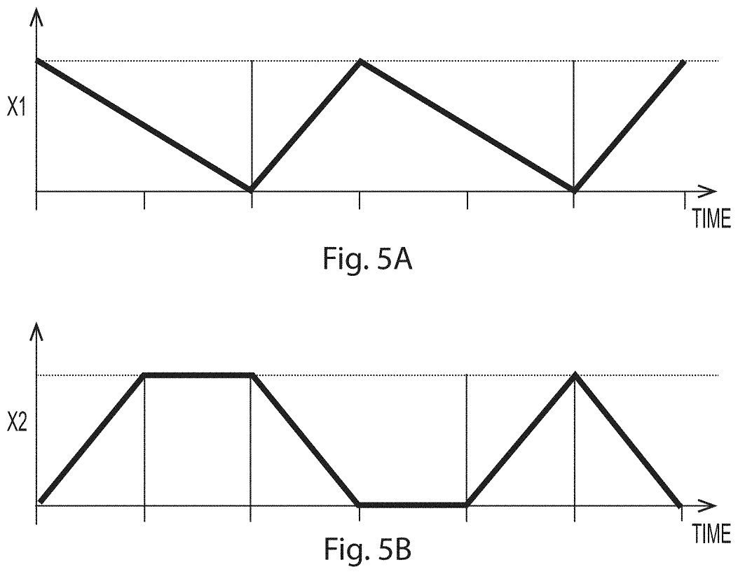

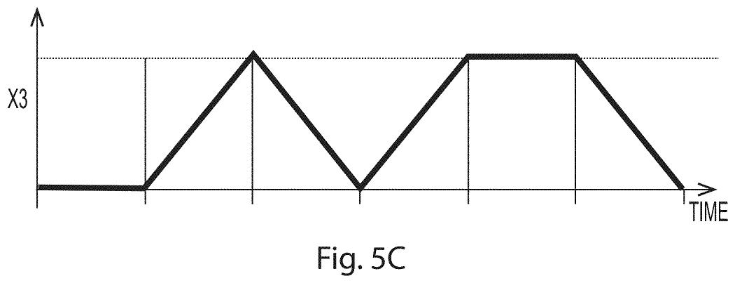

FIGS. 5A-C shows the displacement of each piston versus time of pistons 1, 2, and 3, in FIGS. 5A, 5B, and 5C, respectively. In the example shown in FIG. 5, the order of actuation piston 2 (displacement shown in FIG. 2B) and piston 3 (displacement shown in FIG. 2C) is reversed between cycles. Mixing in this way could also achieve the desired level of mixedness through split and recombination.

In addition to the displacement sequence shown in FIGS. 3-5, there are many other displacement sequences that can result in a desired level of mixedness. For example, variations where the directions of the displacements are reversed (i.e. graphs of FIGS. 3 and 4 are flipped upside-down) can also result in a desired level of mixedness. In addition, variations of the sequence where the displacements are nonlinear in time can also result in a desired level of mixedness. Also, variations where one or more pauses are added to the motion of the moving elements can also result in a desired level of mixedness.

In some examples, the duration of each cycle can be constant. In other examples, the duration of each cycle may not be constant between cycles. It can be advantageous for the sequence to start with slower cycles and faster for the cycles to increase in speed throughout the mixing, which may be advantageous for materials that are initially highly viscous and reduce viscosity when blended. Alternatively, the sequence can have fast cycles initially and slow cycles later.

The positive displacement mixer can have three or more positive displacement elements each having a piston to achieve a desired level of mixedness through the split and recombine cycles. FIG. 1 is a schematic mixer 1 with positive displacement elements 11, 12, and 13.

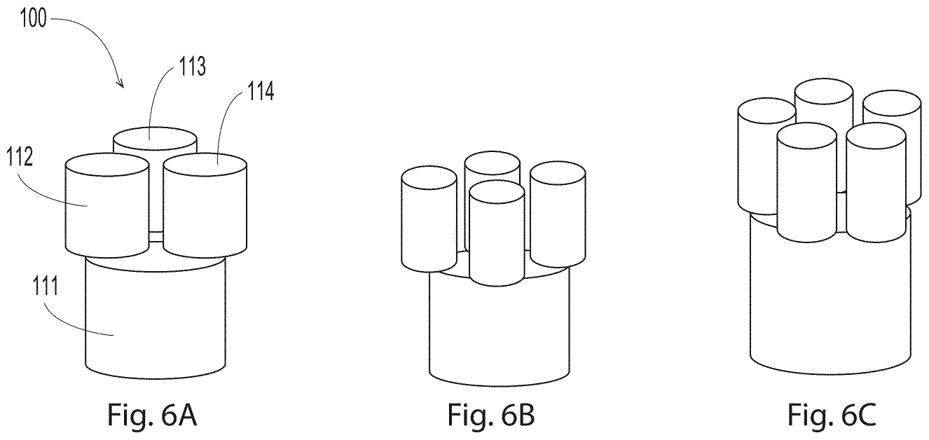

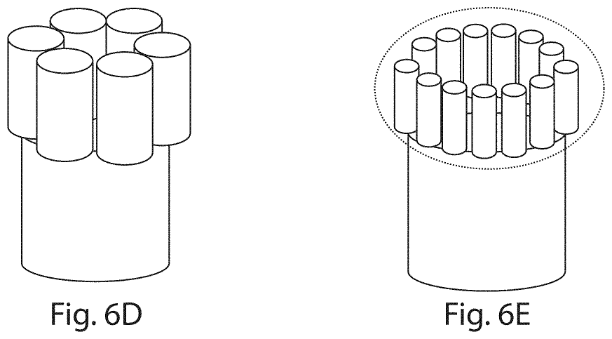

The split and recombine cycle can be achieved with 3 or more positive displacement elements. FIGS. 6A-E illustrate mixers having positive displacement elements. FIG. 6A shows mixer 100 with primary positive displacement element 111 and minor positive displacement elements 112, 113, and 114. During mixing, the materials from primary positive displacement element 111 are split into three portions between minor positive displacement elements 112 113, and 114. FIG. 6B shows a mixer with six positive displacement elements for mixing, FIG. 6C shows a mixer with seven positive displacement elements for mixing, FIG. 6D shows a mixer with eight positive displacement elements for mixing, and FIG. 6E shows a mixer with a plurality of positive displacement elements for mixing.

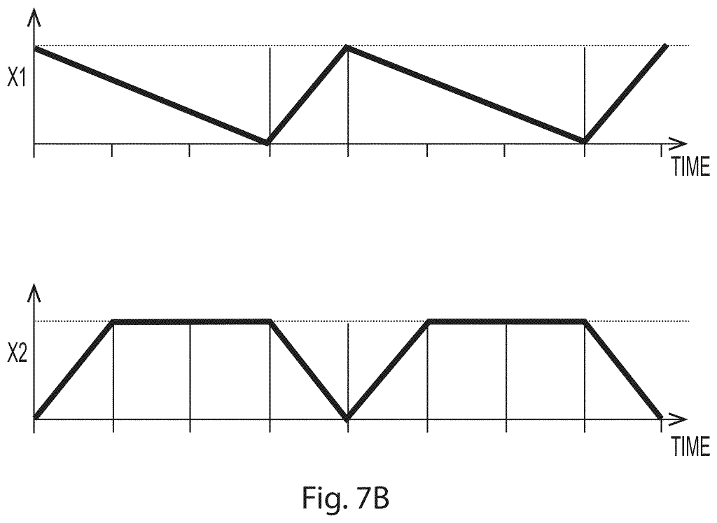

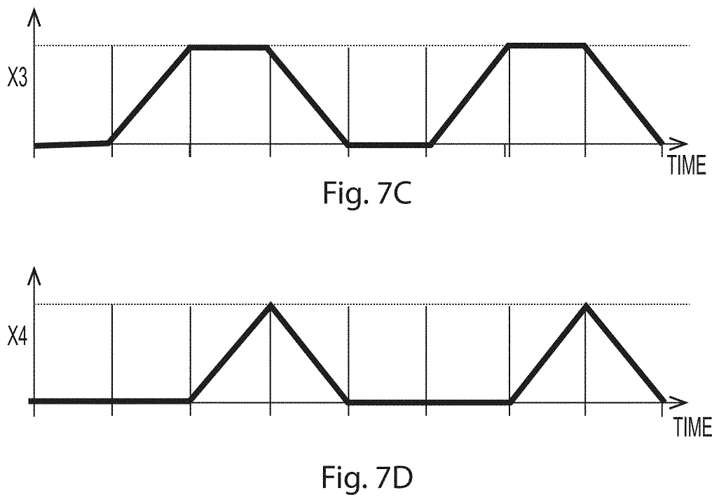

FIGS. 7A-D illustrates the sequence of motion for split and recombination using the mixer of FIG. 6A that has four positive displacement elements each having a piston. In FIG. 7A, the coordinate X1 represents the position of the first piston. In FIG. 7B, X2 represents the position of the second piston. In FIG. 7C, X3 represents the position of the third piston. In FIG. 7D, X4 represents the position of the fourth piston. Variations on this sequence can also achieve a desired level of mixedness. For example, the second, third, and fourth piston can be retracted in any order, so long as they are pushed simultaneously to recombine in the compartment formed by the first piston. Variations where the directions of the displacements are reversed (i.e. graphs of FIGS. 7A-D are flipped upside-down) will also accomplish mixing.

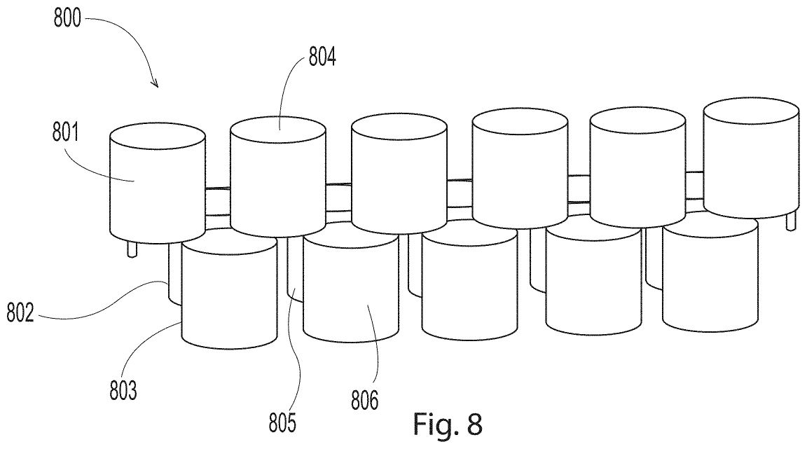

In another example, FIG. 8 shows mixer 800 where the material can be conveyed as it is mixed by using additional positive displacement elements, as shown in FIG. 8. The material can enter positive displacement element 801, split into positive displacement elements 802 and 803, and recombine into positive displacement element 804, then it is split into positive displacement elements 805 and 806, and recombined into positive displacement element 806, and so forth. This configuration permits mixing and conveying of various batches in an “assembly-line” fashion while keeping the contents of each batch isolated from the previous and next one. Such configuration can achieve high rates of production because many cycles are simultaneously executed.

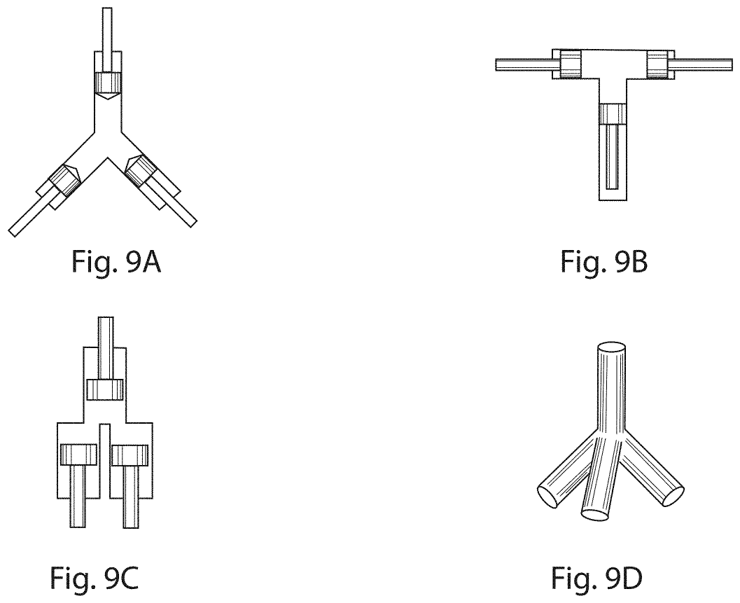

In some examples, the pistons can be colinear. However, the piston configurations shown in the three positive displacement element mixers of FIGS. 9A-9C and the mixer with four positive displacement elements of FIG. 9D can also accomplish desired level of mixedness. In some examples one or more positive displacement elements can meet at approximately a right angle.

The cross-section of the positive displacement elements can be round. However, any the cross-section can be any shape including round shapes, non-round shapes, and combinations thereof. Shapes with curved edges (e.g. circle, oval, rounded triangle, rounded rectangle, or kidney shapes) can be preferred in some examples due to ease of sealing and manufacturing. The moving element can generally have the same cross-section shape as the positive displacement element, so it fits snuggly inside the positive displacement element, while still being able to slide without allowing liquid to seep out of the positive displacement element.

The moving element, such as a piston, can be made from any suitable material. Generally, the moving element materials can minimize friction and leakage, are chemically compatible with the materials being mixed, and are also compatible with any sanitation requirements. The moving element can be selected from the group consisting of close-tolerance ceramics, rigid or elastomeric polymers with good chemical resistance (such as acetal homopolymer (commercially available as Derlin®) and polytetrafluoroethylene (commercially available as Teflon®), stainless steel, chemically resistant alloys, and combinations thereof. One or more moving elements can be rigid.

Alternatively, one or more pistons may not be rigid. The end of one or more moving elements may be elastomeric and shaped to squeeze out most of all material at the end of the mix. The moving elements may have a protrusion that fills the volume of any exit orifices to improve material utilization.

Moving elements, such as pistons, may have a sealing feature to minimize leakage such as elastomer seals for sealing including o-rings, x-rings or cup-shaped seals, spring energized seals, pressure-energized seals, and combinations thereof. In one example, one or more moving elements may have sealing solutions that combine o-rings and backer rings. The seals can be made of any suitable material including, but not limited to, rubber or synthetic rubber such as FKM (commercially available as Viton®), nitrile, perfluoroelastomer (commercially available as Kalrez®), and combinations thereof. In some examples, one or more moving elements do not have a seal and close tolerances can be used to achieve sealing. In addition to or instead of seals, one or more pistons may have wipers to accomplish wiping.

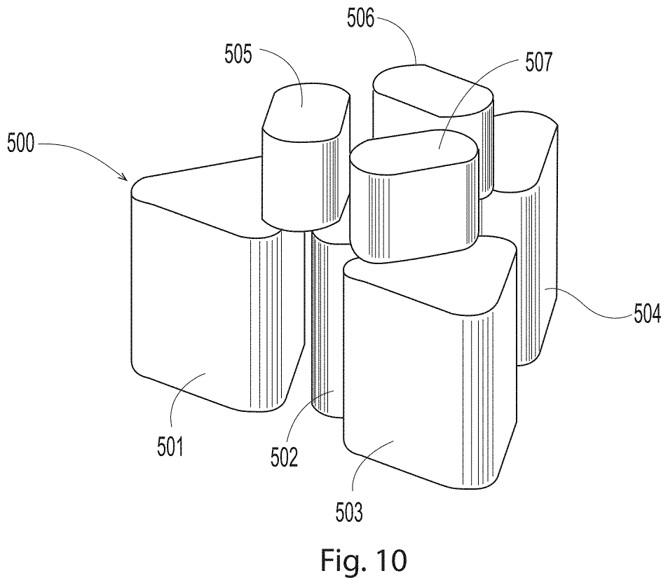

Auxiliary elements may be added between the mixing pistons, these elements can be moving elements such as pistons. FIG. 10, shows positive displacement mixer 500 with four positive displacement elements 501, 502, 503, and 504 having a triangular cross section located at the bottom of mixer 500 that are suitable for mixing. At the top of mixer 500, there are three auxiliary elements 505, 506, and 507 that can control the distance between the positive displacement elements. In some examples, the auxiliary elements can be pistons. If high shear rates are needed during mixing, say for powder incorporation or emulsification, the auxiliary elements can be closed forming a narrow gap to achieve high shearing. Conversely, if the materials need to be protected from excessive shear during mixing, the auxiliary elements can be opened forming a wider gap. At the end of the mixing, the auxiliary elements can be collapsed to zero gap to expel all the fluid, which can help with high material utilization. Shearing between positive displacement elements can also occur by restricting/contracting the flow through the positive displacement elements by any means including, but not limited to, orifice plates, small diameter tubes, slits, venturis, static mixers, needle valves, ball valves, seat valves, strainers, meshes, filters, conical tubes, and combinations thereof.

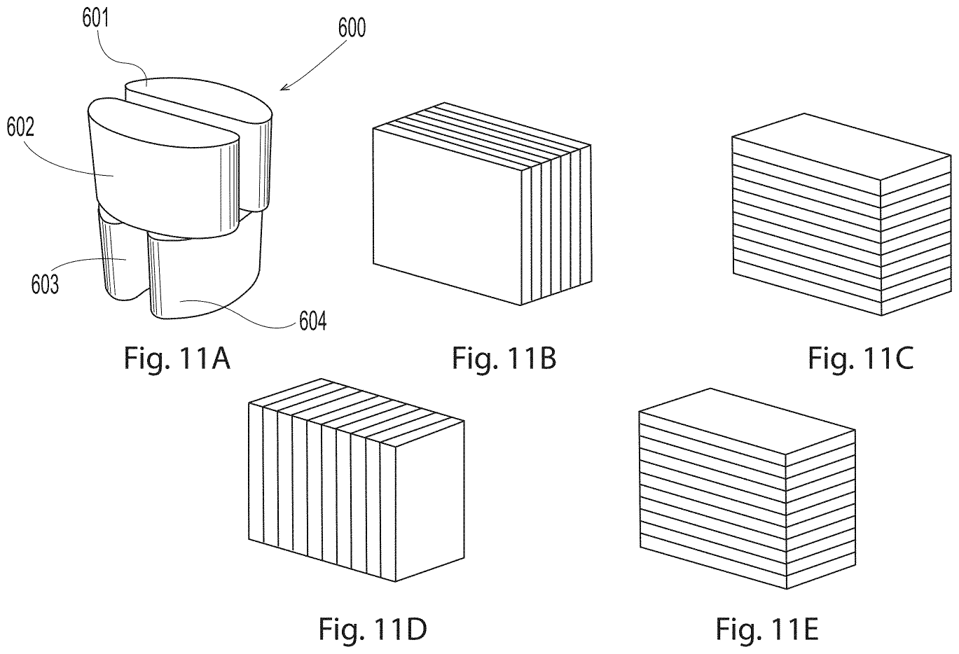

In some examples, the mixer can have one primary positive displacement element that can include a compartment and a piston. Alternatively, the mixer can have two or more primary displacement elements each can have a compartment and a piston, and the split and recombine mixing can occur when the two positive displacement elements move together as one. FIG. 11A shows positive displacement mixer 600 where the two bottom positive displacement elements 603 and 604 can act as the primary positive displacement elements and the two top positive displacement elements 601 and 602 can act as the minor positive displacement elements. In such a configuration, the mixer can achieve horizontal lamination, as shown in FIG. 11B, using Mixing Method A, described herein, and vertical lamination, as shown in FIG. 11C, which is transverse to the lamination in FIG. 11B, using Mixing Method B, described herein.

A different lamination pattern can occur when the materials are simultaneously transferred from minor positive displacement elements 601 and 602 to primary displacement elements 603 and 604 and then transferred from primary displacement elements 603 and 604 to minor positive displacement elements 603 and 604 one at a time. In such a configuration, the mixer can achieve vertical lamination, as shown in FIG. 11D, which is transverse to the vertical lamination shown in FIG. 11B and the horizontal lamination of FIGS. 11C and 11E.

The materials can also be transferred from minor positive displacement elements 601 and 602 to primary displacement elements 603 and 604 one at a time and then simultaneously transferred from primary displacement elements 603 and 604 to minor positive displacement elements 601 and 602. In such a configuration, the mixer can horizontal lamination of 11E which is transverse to the vertical lamination shown in FIGS. 11B and 11D.

As shown in FIGS. 11B-D, Positive displacement mixer 600 can laminate in three perpendicular directions. To obtain the desired level of mixedness it can be advantageous to use a cycle that includes mixing cycles to get two or three mixing patterns. For example, the mixing cycle could include 15 cycles in the direction that produces the lamination pattern in FIGS. 11B and/or 11E, 15 cycles that produces the lamination pattern in FIG. 11C, and 15 cycles that produces the lamination pattern in FIG. 11D.

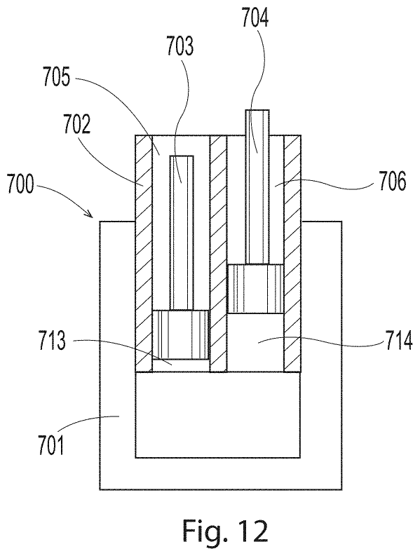

FIG. 12 is a cross-section view showing positive displacement mixer 700, which functions like a three-piston mixer. Mixer 700 has positive displacement elements 705 and 706 having pistons 703 and 704 and minor compartments 713 and 714, respectively. However, instead of having a third piston, mixer 700 has container 701 with movable lid 702. The relative motion of lid 702 and container 701 can make the primary compartment of variable volume. The pistons 703 and 704 more relative to the lid. The displacement of pistons 703 and 704 relative to lid 702 make the minor compartments 713 and 714.

In order to get high material utilization from the positive displacement mixer, the following steps can be used to load and unload the materials into and out of the mixer.

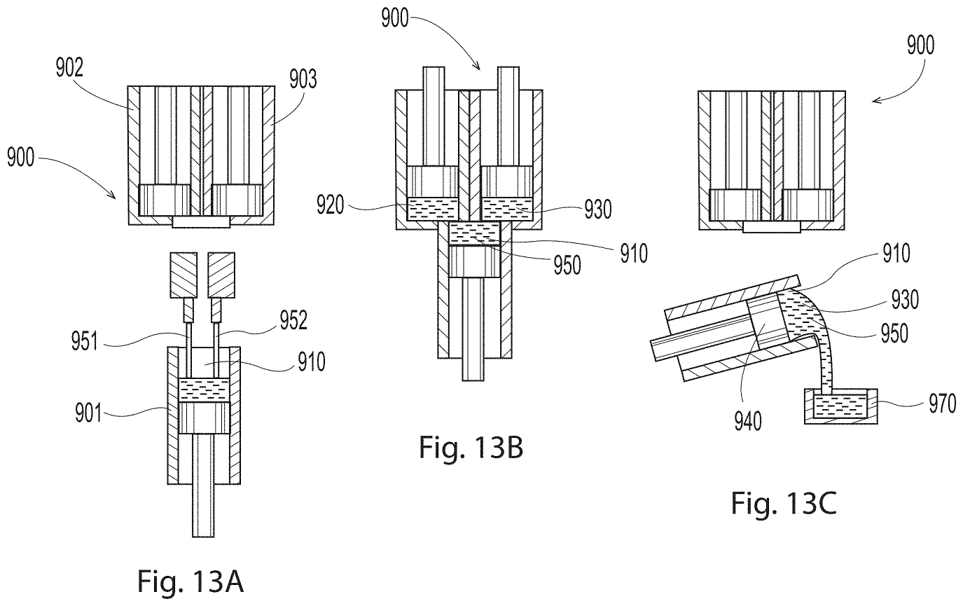

Loading the materials can be done as follows: Inject the materials into a compartment that can be connected to other compartments through fluid communication. FIG. 13A is a cross-section view of positive displacement mixer 900 with positive displacement elements 901, 902, and 903. In FIG. 13A, materials 951 and 952 are injected into an open compartment 910 that is subsequently connected positive displacement elements 902 and 903. In this example, the open compartment 910 is the primary compartment of piston 901. When the open compartment 910 is closed, mixing can begin.

FIG. 13B is a cross-section of the positive displacement mixer 900 at a point during mixing. Compartments 910, 920, and 930 are connected and filled with material 950, which is a combination of materials 951 and 952 as shown in FIG. 13A. In FIG. 13B, the volume of compartments 910 and 920 have increased when compared to FIG. 13A where the pistons are fully distended to the bottom of the positive displacement element and the volume of compartment 910 has decreased as comparted to FIG. 13A, forcing material 950 into compartments 920 and 930 thereby mixing it.

FIG. 13C is a cross-section of the positive displacement mixer 900 when the material 950 is being poured from compartment 930 into container 970. Unloading the materials can be done as follows: material 950 is moved to the primary compartment 910 and primary positive displacement element 901 is removed from positive displacement mixer 900. Material 950 is then pushed with piston 940 through the opening of positive displacement element 901 and into a separate container 970.

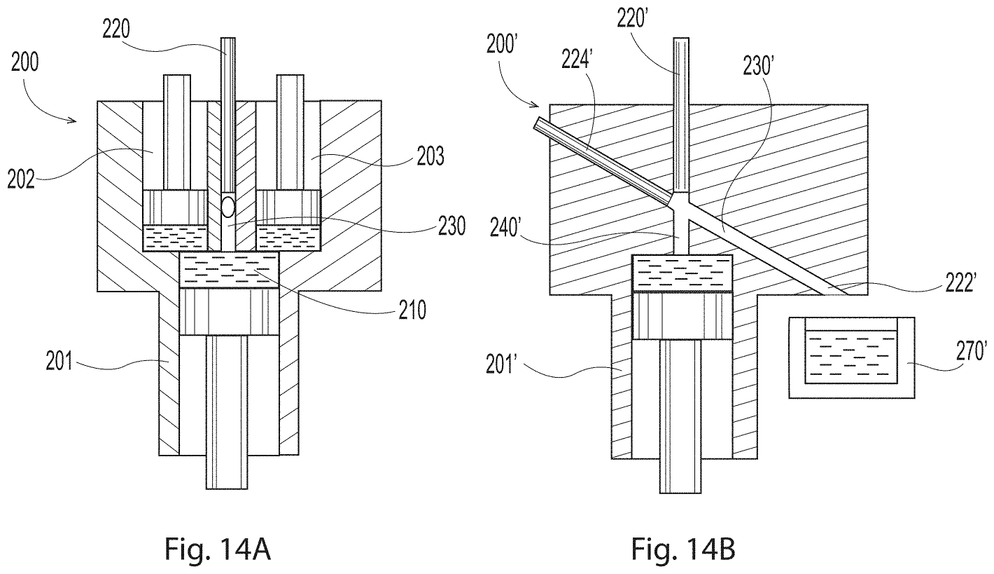

FIGS. 14A-B show other ways to load and unload the materials to get high material utilization. FIG. 14A shows positive displacement mixer 200 with primary positive displacement element 201 and minor positive displacement element 202 and 203. FIG. 14A has movable member 220, which can be removed exposing channel 230. After member 220 is removed, the material can be loaded through channel 230 and into primary compartment 210.

FIG. 14B shows positive displacement mixer 200′ with primary positive displacement element 201′. FIG. 14B is similar to FIG. 14A, except it has two movable members 220′ and 224′ and two channels 230′ and 240′ and the two mixing positive displacement elements are removed from FIG. 14B to more clearly show the channels 230′ and 240′, however, they are included in displacement mixer 200′. Channel 230′ is for loading the material into the mixer and channel 240′ is for unloading the mixer. The loading and unloading channels can be closed during mixing. In order to unload the material, movable members 220′ and 224′ are moved so they are not blocking the portion of the channel between the primary chamber 211′ and exit orifice 222′. Movable member 224′ is also moved so it is not blocking exit hold 222′. Then, positive displacement element 214′ of primary positive displacement element 201′ is pushed, pushing material out of primary positive displacement element 201′ and into channel ‘240 and then through exit orifice 222’ and into separate container 270′. The loading and unloading channels can be wiped clean during and/or after dispensing.

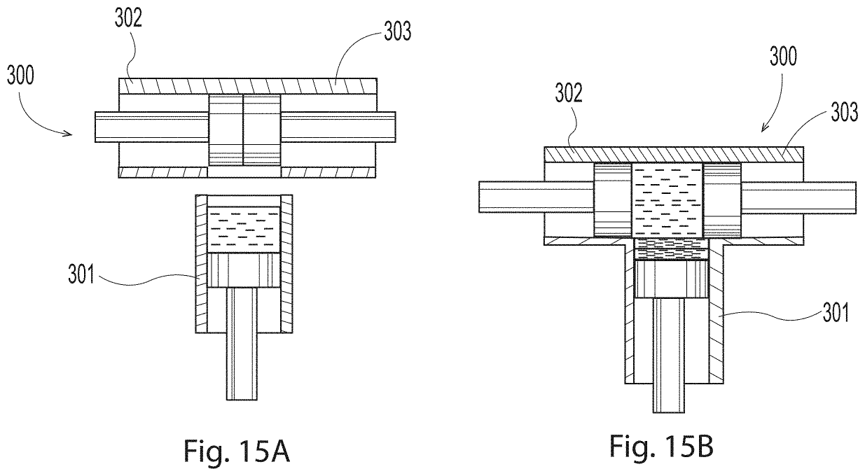

FIGS. 15A and 15B show positive displacement mixer 300, where positive displacement elements 301, 302, and 303 are arranged in a T-configuration. A lower detachable positive displacement element 301 is loaded with materials to be mixed. The lower positive displacement element 301 is attached to the bottom of a two-piston array that comprises positive displacement element 302 and 303. positive displacement element 301, 302, and 303 combine to become mixer 300, shown in FIG. 15B. After undergoing one or more mixing cycles the material is unloaded using high utilization methods such as those depicted in FIGS. 14 and 15 and accompanying text. A further benefit to the positive displacement mixer describer herein is that the scaleup process is simplified, since the mixing can be independent of Reynolds number. Furthermore, mixing is independent of the aspect ratio of the equipment. The batch size can be modified by changing the stroke length of the movable element thereby changing the size of the compartment, or the diameter of the pistons to achieve a larger or smaller batch size.

For in-store applications or to increase throughput in a manufacturing setting, a short mixing time can be preferred. In some examples each cycle takes 1-10 seconds, alternatively 1-5 seconds, and alternatively 2-4 seconds. It can take from 5-60 cycles to achieve the desired level of mixedness, which can be homogeneity, alternatively 10-50 cycles, alternatively 13-40 cycles, and alternatively 15-30 cycles. It can take from 5 seconds to 10 minutes to achieve the desired level of mixedness, alternatively from about 10 seconds to 8 minutes, alternatively from about 15 seconds to 6.5 minutes, alternatively from about 30 seconds to about 5 minutes, alternatively from about 60 seconds to about 4 minutes, and alternatively from about 90 seconds to about 3 minutes.

It was found that the time to complete each cycle can be increased without significantly impacting the rheology of the product. In some examples, each cycle can take less than 1 second and the time per cycle and the total time to reach the desired level of mixedness can be less than 2 minutes, alternatively less than 90 seconds, alternatively less than 60 seconds, alternatively less than 45 seconds, and alternatively less than 30 seconds.

Another benefit to the positive displacement mixer described herein is that since the mixing principle is geometric, geometric rather than inertial the range of materials that can be mixed is much wider than for conventional mixers that require turbulence. The mixer can be suitable for any material that can be pushed by movable elements, like pistons, including:
Materials ranging in viscosity from thin water-like materials to thick paste-like or solid-like deformable materials that contain solid crystalline-structures (like fatty alcohol gel network or wax). The final product can have a viscosity of from about 1 Pa*s to about 1700 Pa*s, alternatively from about 5 Pa*s to about 1500 Pa*s, alternatively from about 10 Pa*s to about 1200 P*s, and alternatively from about 20 Pa*s to about 500 P*s, according to the Viscosity Measurement, described herein.
Materials ranging in rheology properties including Newtonian fluids, non-Newtonian fluids, which are shear thinning
Immiscible materials like oil and water, or silicone and water
Materials that contain high viscosity differences or rheological properties, like mixing water-like Newtonian fluids and non-Newtonian, high yield stress fluids.
Mixing a dry, non-soluble powder into a water-based fluid (like skin cream or conditioner)
Mixing a dry, water-soluble powder into a water-based fluid (like skin cream or Conditioner)

The final product can be a beauty care product, which includes products for or methods relating to: (a) the care, treatment, imaging or evaluation of hair, including, but not limited to bleaching, coloring, dyeing, conditioning, growing, removing, retarding growth, cleansing, shampooing, and styling; (b) the care, treatment, imaging or evaluation of perspiration and/or body odor, including fragrance compositions, deodorants, and antiperspirants; (c) personal cleansing and make-up removal, including, but not limited to imaging, evaluating, cleansing and/or exfoliating the skin and/or nails and removal of topical beauty care products from the skin and/or nails; (d) the care, treatment, imaging or evaluation of the skin or nails by means of topically administered materials including, but not limited to, application of creams, lotions, serums and other topically applied products for purposes including, but not limited to, enhancing the appearance, health and/or feel of the skin and/or nails; and (e) the care, treatment of skin, hair and/or and nails by means of orally administered materials for purposes including, but not limited to, enhancing the appearance, feel and/or health of hair, skin, or nails. As used in this definition, skin includes all skin on the body, including the scalp, hands, feet, face, and body; and as used in this definition, hair includes all hair anywhere on the body.

### EXAMPLES

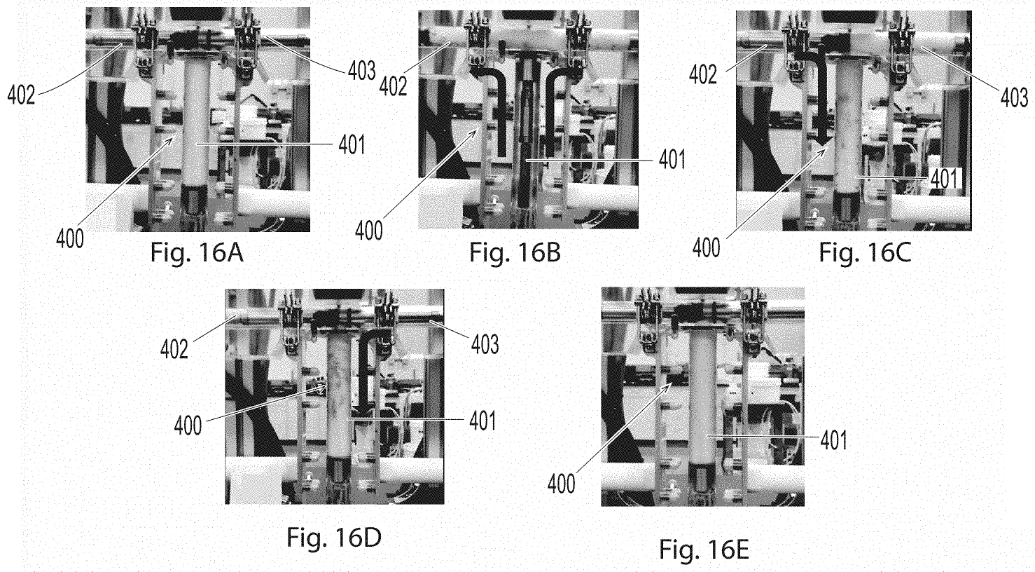

FIGS. 16A-E are still frames from a video that show mixer 400 with primary positive displacement element 401 and minor positive displacement elements 402 and 403. FIG. 16A shows mixer 400 after it is loaded with the materials and before mixing begins. FIGS. 16B-D show one mixing cycle, which occurs over approximately 2.25 seconds. FIG. 16E shows a homogeneous product after 60 mixing cycles that occur over approximately 2.2 minutes.

FIG. 16A is at the start of mixing where the materials (conditioner and blue dye) are loaded into primary positive displacement element 401. Next, as shown in FIG. 16B, the materials are split and simultaneously transferred to minor positive displacement elements 402 and 403. Then, as shown in FIG. 16C, the material in minor displacement element 402 is transferred back to primary positive displacement element 401. After that, as shown in FIG. 16D, the material in minor positive displacement element 402 is transferred to primary positive displacement element 401 and one mixing cycle is complete. In this example, the mixing cycle is repeated until the material is homogenous, as shown in FIG. 16E.

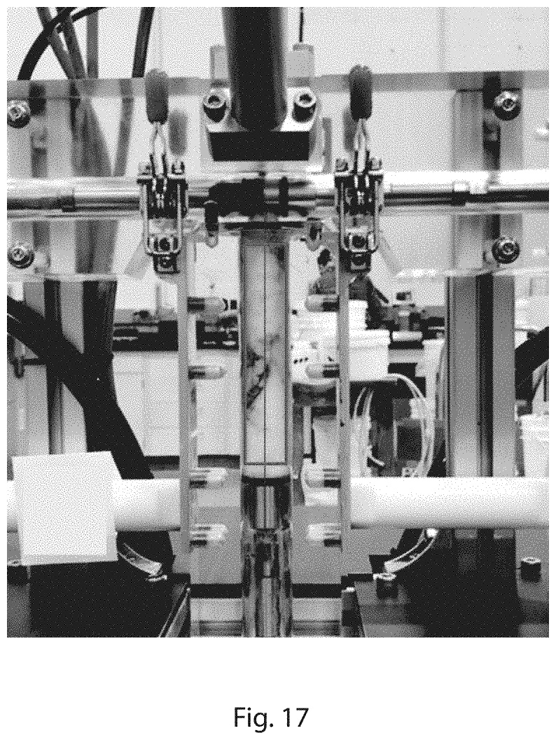

A photograph of a T-shaped mixer with three positive displacement elements each having one piston is shown in FIG. 17. This mixer was used to combine 64% hair conditioner and 36% water containing red or blue dye to evaluate mixing by analyzing images analyzed at the end of each cycle in the region shown by a rectangle in FIG. 17. The image is converted from RGB (red, green blue) to HSV (hue, saturation, value) components using the module rgb2hsv from the Python Library scikit-image (Version 0.14.2, accessed Jan. 1, 2019). The saturation component of each pixel is used to detect the amount of dye for being less sensitive to illumination differences. As a mixedness measure the coefficient of variation of the hue component in all the pixels in the rectangle of interest was computed (i.e. if all pixels have the same value then the coefficient of variation will be low, indicating well-mixedness, if there's great differences in values between pixels the coefficient will be large indicating poor mixedness).

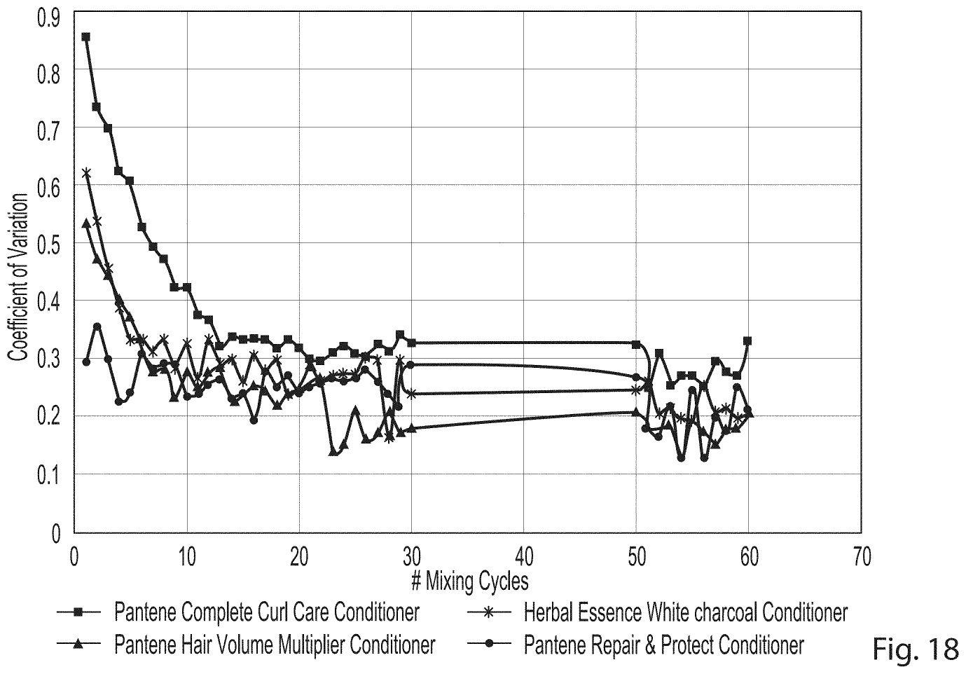

FIG. 18 shows the mixedness measure as a function of cycle number for the following hair conditioners mixed with water containing blue or red dye: Pantene® Complete Curl Care Conditioner, Pantene® Nutrient Volume Multiplier Conditioner, Herbal Essences® White Activated Charcoal Conditioner, and Pantene® Repair and Protect Conditioner. It is observed that the coefficient of variation is initially high, indicating poor initial mixedness. As the number of cycles increases coefficient of variation decreases, up to a point where it remains relatively constant.

### TEST METHODS

### Viscosity Measurement

The viscosities of formulations are measured by a Cone/Plate Controlled Stress Brookfield Rheometer R/S Plus, by Brookfield Engineering Laboratories, Stoughton, Mass. The cone used (Spindle C-75-1) has a diameter of 75 mm and 1° angle. The viscosity is determined using a steady state flow experiment at constant shear rate of 0.1 s⁻¹ and at temperature of 26.5° C. The sample size is 2.5 ml and the total measurement reading time is 3 minutes.

### Combinations:

A. A method for mixing a product, the method comprising:
a. providing a positive displacement mixer comprising:
   i. one or more primary positive displacement elements each comprising a primary compartment comprising a primary volume and a length;
   ii. two or more minor positive displacement elements each comprising a minor compartment comprising a minor volume and a length; wherein the one or more primary compartments and the two or more minor compartments are fluidly connected;
b. loading the one or more primary compartments with at least two materials;
c. closing the primary and minor positive displacement elements to the atmosphere;
d. mixing the one or more materials using laminar flow by a mixing method selected from the group consisting of Method A, Method B, Method C, and combinations thereof;
wherein Method A comprises:
   i. transferring the materials from the one or more primary compartments to each minor compartment one at a time;
   ii. then, simultaneously transferring the material from the minor compartments to the one or more primary compartments to complete one cycle;
   iii. repeating steps i to ii until the desired level of mixedness is obtained forming a product;
wherein Method B comprises:
   i. simultaneously transferring the materials from the one or more primary compartments to the two or more minor compartments;
   ii. then, transferring all the material from each minor compartment to the primary compartment one at a time to complete one cycle;
   iii. repeating steps i to ii until the desired level of mixedness is obtained forming a product;
wherein Method C comprises:
   i. simultaneously transferring the materials from the one or more primary compartments to the two or more minor compartments;
   ii. then, simultaneously transferring the material from the minor compartments to the one or more primary compartments to complete one cycle;
   iii. repeating steps i to ii until the desired level of mixedness is obtained forming a product;
e. dispensing the product into a final container.

B. A method for mixing a product
a. providing a positive displacement mixer comprising:
   i. two or more primary positive displacement elements each comprising a primary compartment comprising a primary volume;
   ii. two or more minor positive displacement elements each comprising a minor compartment comprising a minor volume; wherein the two or more primary compartments and the two or more minor compartments are fluidly connected;
b. loading the two or more primary compartments with at least two materials in each primary compartment or loading the two or more minor compartments with at least two materials in each compartment;
c. closing the primary and minor positive displacement elements to the atmosphere;
d. mixing the one or more materials using laminar flow by a mixing method selected from the group consisting of Method A, Method B, Method C, Method D, and Method E, and combinations thereof;
wherein Method A comprises:
   i. transferring the materials from the one or more primary compartments to each minor compartment one at a time;
   ii. then, simultaneously transferring the material from the minor compartments to the one or more primary compartments to complete one cycle;
   iii. repeating steps i to ii until the desired level of mixedness is obtained forming a product;
wherein Method B comprises:
   i. simultaneously transferring the materials from the one or more primary compartments to the two or more minor compartments;
   ii. then, transferring all the material from each minor compartment to the primary compartment one at a time to complete one cycle;
   iii. repeating steps i to ii until the desired level of mixedness is obtained forming a product;
wherein Method C comprises:
   i. simultaneously transferring the materials from the one or more primary compartments to the two or more minor compartments;
   ii. then, simultaneously transferring the material from the minor compartments to the one or more primary compartments to complete one cycle;
   iii. repeating steps i to ii until the desired level of mixedness is obtained forming a product;
wherein Method D comprises:
   i. transferring the materials from the two or more minor compartments to each primary compartment one at a time;
   ii. then, simultaneously transferring the material from the two or more primary compartments to the two or more minor compartments to complete one cycle;
   iii. repeating steps i to ii until the desired level of mixedness is obtained forming a product;
wherein Method E comprises:
   i. simultaneously transferring the materials from the two or more minor compartments to the two or more primary compartments;
   ii. then, transferring all the material from each primary compartment to the minor compartments one at a time to complete one cycle;
   iii. repeating steps i to ii until the desired level of mixedness is obtained forming a product;
e. dispensing the product into a final container.

C. The method according to Paragraphs A-B, wherein each primary displacement element further comprises a moving element and wherein each minor displacement element further comprises a moving element; wherein the one or more primary compartments and the two or more minor compartments comprise variable volumes as determined by moving the moving element across the length of the positive displacement element.

D. The method according to Paragraph C, wherein one or more of the moving elements is a piston.

E. The method according to Paragraphs C-D, wherein the moving element dispenses the product from the one or more primary compartments and/or the two or more minor compartments into the final container.

F. The method according to Paragraphs C-E, where the moving element transfers the material from the one or more primary compartments to the two or more minor compartments and/or the moving element transfers the material from the two or more minor compartments to the primary compartments.

G. The method according to Paragraphs A-F, wherein at least one material consists of an immiscible fluid added in neat form.

H. The method according to Paragraph G, wherein the added material comprises silicone.

I. The method according to Paragraphs A-H, wherein the mixing device does not cause aeration and/or foam during mixing.

J. The method according to Paragraphs A-I, wherein after the mixer is closed there is substantially no headspace in the primary and minor compartments.

K. The method according to Paragraphs A-J, wherein steps b-e are repeated to mix a second product without washing the positive displacement mixer.

L. The method according to Paragraphs A-K, wherein the final container comprises a volume from about 25 mL to about 1500 mL.

M. The method according to Paragraphs A-L, wherein the mixing method completes from about 15 to about 30 cycles to reach the desired level of mixedness.

N. The method according to Paragraphs A-M, wherein the desired level of mixedness produces a homogenous product.

O. The method according to Paragraphs A-N, wherein during mixing the positive displacement elements have a linear motion.

P. The method according to Paragraphs A-O, wherein during mixing the moving elements have a non-linear motion.

Q. The method according to Paragraph B, whereby a combination of Methods A, B, D, and E results in three different lamination patterns.

R. The method according to Paragraphs B and Q, wherein the two or more primary positive displacement elements further comprise a primary plane of symmetry and the two or more minor displacement elements further comprise a minor plane of symmetry; wherein the primary plane of symmetry and the minor plane of symmetry are orthogonal.

S. A positive displacement mixer for mixing a product that mixes at least two materials into a homogenous product, the device comprising:
a. at least three positive displacement elements comprising:
   i. a primary positive displacement element comprising a length, primary compartment, and a moving element;
   ii. two or more minor positive displacement elements each comprising a length, a minor compartment, and a moving element;
wherein the primary compartment and the minor compartments are fluidly connected;
wherein during mixing the primary compartment and minor compartments are closed to the atmosphere;
wherein the primary compartment and the minor compartments comprise variable volumes as determined by moving the moving element across the length of the positive displacement elements.

T. The method according to Paragraph S, wherein the positive displacement mixer comprises three or four positive displacement elements.

U. The method according to Paragraphs S-T, wherein the mixer comprises three positive displacement element arranged in a T-configuration and the primary positive displacement element is detachable.

V. The method according to Paragraphs S-U, wherein the positive displacement mixer further comprises one or more auxiliary elements adapted to change the spacing between the positive displacement elements.

W. The method according to Paragraphs S-V, further comprising a channel adapted for filling the primary compartment and/or unloading the product from the mixer wherein the channel is fluidly connected to the primary chamber and the atmosphere.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for mixing a product, the method comprising the steps of:
a. providing a positive displacement mixer comprising:
i. one or more primary positive displacement elements each comprising a primary compartment comprising a primary volume and a length;
ii. two or more minor positive displacement elements each comprising a minor compartment comprising a minor volume and a length;
wherein the one or more primary compartments and the two or more minor compartments are fluidly connected;
b. loading the one or more primary compartments with at least two materials;
c. closing the primary and minor positive displacement elements to the atmosphere;
d. mixing the one or more materials using laminar flow by a mixing method selected from the group consisting of Method A, Method B, Method C, and combinations thereof;
wherein Method A comprises:
i. transferring the materials from the one or more primary compartments to each minor compartment one at a time;
ii. then, simultaneously transferring the material from the minor compartments to the one or more primary compartments to complete one cycle;
iii. repeating steps i to ii until the desired level of mixedness is obtained forming a product;
wherein Method B comprises:
i. simultaneously transferring the materials from the one or more primary compartments to the two or more minor compartments;
ii. then, transferring all the material from each minor compartment to the primary compartment one at a time to complete one cycle;
iii. repeating steps i to ii until the desired level of mixedness is obtained forming a product;
wherein Method C comprises:
i. simultaneously transferring the materials from the one or more primary compartments to the two or more minor compartments;
ii. then, simultaneously transferring the material from the minor compartments to the one or more primary compartments to complete one cycle;
iii. repeating steps i to ii until the desired level of mixedness is obtained forming a product;
e. dispensing the product into a final container.

2. The method of claim 1, wherein each primary displacement element further comprises a moving element and wherein each minor displacement element further comprises a moving element; wherein the one or more primary compartments and the two or more minor compartments comprise variable volumes as determined by moving the moving element across the length of the positive displacement element.

3. The method of claim 2, wherein one or more of the moving elements is a piston.

4. The method of claim 2, wherein the moving element dispenses the product from the one or more primary compartments and/or the two or more minor compartments into the final container.

5. The method of claim 2, where the moving element transfers the material from the one or more primary compartments to the two or more minor compartments and/or the moving element transfers the material from the two or more minor compartments to the primary compartments.

6. The method of claim 1, wherein at least one material consists of an immiscible fluid added in neat form.

7. The method of claim 6, wherein the added material comprises silicone.

8. The method of claim 1, wherein the mixing device does not cause aeration and/or foam during mixing.

9. The method of claim 1, wherein after the mixer is closed there is substantially no headspace in the primary and minor compartments.

10. The method of claim 1, wherein steps b-e are repeated to mix a second product without washing the positive displacement mixer.

11. The method of claim 1, wherein the final container comprises a volume from about 25 mL to about 1500 mL.

12. The method of claim 1, wherein the desired level of mixedness produces a homogenous product.

13. A method for mixing a product, the method including the following steps:
a. providing a positive displacement mixer comprising:
i. two or more primary positive displacement elements each comprising a primary compartment comprising a primary volume;
ii. two or more minor positive displacement elements each comprising a minor compartment comprising a minor volume;
wherein the two or more primary compartments and the two or more minor compartments are fluidly connected;
b. loading the two or more primary compartments with at least two materials in each primary compartment or loading the two or more minor compartments with at least two materials in each compartment;
c. closing the primary and minor positive displacement elements to the atmosphere;
d. mixing the one or more materials using laminar flow by a mixing method selected from the group consisting of Method A, Method B, Method C, Method D, and Method E, and combinations thereof;
wherein Method A comprises:
i. transferring the materials from the one or more primary compartments to each minor compartment one at a time;
ii. then, simultaneously transferring the material from the minor compartments to the one or more primary compartments to complete one cycle;
iii. repeating steps i to ii until the desired level of mixedness is obtained forming a product;
wherein Method B comprises:
i. simultaneously transferring the materials from the one or more primary compartments to the two or more minor compartments;
ii. then, transferring all the material from each minor compartment to the primary compartment one at a time to complete one cycle;
iii. repeating steps i to ii until the desired level of mixedness is obtained forming a product;
wherein Method C comprises:
i. simultaneously transferring the materials from the one or more primary compartments to the two or more minor compartments;
ii. then, simultaneously transferring the material from the minor compartments to the one or more primary compartments to complete one cycle;
iii. repeating steps i to ii until the desired level of mixedness is obtained forming a product;
wherein Method D comprises:
i. transferring the materials from the two or more minor compartments to each primary compartment one at a time;
ii. then, simultaneously transferring the material from the two or more primary compartments to the two or more minor compartments to complete one cycle;
iii. repeating steps i to ii until the desired level of mixedness is obtained forming a product;
wherein Method E comprises:
i. simultaneously transferring the materials from the two or more minor compartments to the two or more primary compartments;
ii. then, transferring all the material from each primary compartment to the minor compartments one at a time to complete one cycle;
iii. repeating steps i to ii until the desired level of mixedness is obtained forming a product;
e. dispensing the product into a final container.

14. The method of claim 13, whereby a combination of Methods A, B, D, and E results in three different lamination patterns.

15. The method of claim 13, wherein the two or more primary positive displacement elements further comprise a primary plane of symmetry and the two or more minor displacement elements further comprise a minor plane of symmetry; wherein the primary plane of symmetry and the minor plane of symmetry are orthogonal.

16. A positive displacement mixer for mixing a product that mixes at least two materials into a homogenous product, the device comprising:
at least three positive displacement elements comprising:
i. a primary positive displacement element comprising a length, primary compartment, and a moving element; and
ii. two or more minor positive displacement elements each comprising a length, a minor compartment, and a moving element;
wherein the primary compartment and the minor compartments are fluidly connected;
wherein during mixing the primary compartment and minor compartments are closed to the atmosphere; and
wherein the primary compartment and the minor compartments comprise variable volumes as determined by moving the moving element across the length of the positive displacement elements.

17. The positive displacement mixer of claim 16, wherein the positive displacement mixer comprises three or four positive displacement elements.

18. The positive displacement mixer of claim 16, wherein the positive displacement mixer included three positive displacement elements arranged in a T-configuration and the primary positive displacement element is detachable.

19. The positive displacement mixer of claim 16, wherein the positive displacement mixer further comprises one or more auxiliary elements adapted to change the spacing between the positive displacement elements.

20. The positive displacement mixer of claim 16, further comprising a channel adapted for filling the primary compartment and/or unloading the product from the mixer wherein the channel is fluidly connected to the primary chamber and the atmosphere.
